(19) United States
(12) Patent Application Publication
(10) Pub. No.: US 2023/0050445 A1
(43) Pub. Date: Feb. 16, 2023

(54) BRIDGE MODEL UPDATING METHOD, SYSTEM, STORAGE MEDIUM AND DEVICE OF BASED ON THE MODIFICATION OF VEHICLE-BRIDGE COUPLING FORCE

(71) Applicants: Harbin Institute of Technology, Harbin (CN); Zhong Dian Jian Ji Jiao Expresswayinvestment Development Co., Ltd., Shijiazhuang (CN); Harbin Institute of Technology (Beijing) Industrial Technology Innovation Research Institute Co.,Ltd, Beijng (CN)

(72) Inventors: Yong DING, Harbin (CN); Zhiqiang ZHANG, Shijiazhuang (CN); Jian LIU, Shijiazhuang (CN); Tong ZHOU, Shijiazhuang (CN); Xianzhuo JIA, Shijiazhuang (CN); Ying CHANG, Shijiazhuang (CN); Bin ZHU, Shijiazhuang (CN); Guang CHEN, Shijiazhuang (CN); Cong ZENG, Shijiazhuang (CN)

(73) Assignees: Harbin Institute of Technology, Harbin (CN); Zhong Dian Jian Ji Jiao Expresswayinvestment Development Co., Ltd., Shijiazhuang (CN); Harbin Institute of Technology (Beijing) Industrial Technology Innovation Research Institute Co.,Ltd, Beijng (CN)

(21) Appl. No.: 17/936,866

(22) Filed: Sep. 30, 2022

Related U.S. Application Data
(63) Continuation of application No. PCT/CN2022/071663, filed on Jan. 12, 2022.

(30) Foreign Application Priority Data
Jun. 9, 2021 (CN) 202110641202.4

(51) Int. Cl. G06F 30/13; G06F 30/23

(52) U.S. Cl. CPC G06F 30/13; G06F 30/23

(57) ABSTRACT

A bridge structure dynamic response of a bridge structure under the action of heavy duty vehicle load is obtained through sensors arranged on the bridge structure; according to vertical vibration acceleration aₒ and vertical deflection yₒ of the bridge at a center of gravity o of the heavy duty vehicle and speed of the heavy duty vehicle U_{vehicle}, a response of a table top of a vibration table is reconstructed, and interaction force of the vehicle-bridge coupling model is obtained; a nonlinear finite element model of the bridge structure is established, and the vehicle-bridge interaction force is taken as external force, and the dynamic response of the bridge structure is taken as a structural response, and modification of the finite element model of the bridge structure is completed through a nonlinear parameter identification method. The invention is mainly used for updating a bridge model.

### CROSS-REFERENCE TO RELATED APPLICATIONS

This application is a continuation of International Patent Application No. PCT/CN2022/071663 with a filing date of Jan. 12, 2022, designating the United States, now pending, and further claims priority to Chinese Patent Application No. 202110641202.4 with a filing date of Jun. 9, 2021. The content of the aforementioned applications, including any intervening amendments thereto, are incorporated herein by reference.

### TECHNICAL FIELD

The present invention belongs to the technical field of engineering, and in particularly relates to a method, a system and device for finely updating a finite element model of a highway bridge.

### BACKGROUND

The rapid development of infrastructure represented by highway bridge is an important cornerstone of China's sustained economic growth. As an important transportation hub, highway bridges are of great significance for promoting material transportation, improving traffic conditions in remote areas and realizing regional economic development. However, with the rapid expansion of logistics business at home and abroad, heavy-duty and super-heavy-duty load cases occur from time to timer. Such heavy-duty vehicles that exceed the design load of bridge in normal use are likely to cause irreversible damage to the bridge, seriously affecting the safety and durability of the bridge in its design life cycle.

In recent years, bridge collapse accidents caused by heavy-duty vehicles frequently occur. For example, in June 2015, the Heyuan ramp bridge of Jiangxi-Hubei Expressway collapsed, with a design load of 110t and an actual heavy load of 360 t; In October, 2019, Auxin Viaduct collapsed in Jiangsu Province, with the design load of 110t and the actual heavy-duty vehicle load of 183t. The collapse and failure of bridge structures not only cause huge economic losses, but also cause bad social impacts. Therefore, it is particularly important to focus on the safety assessment issues of heavy-duty vehicles crossing bridges. The safety assessment work of heavy-duty vehicles crossing bridges is inseparable from the bridge numerical simulation calculation. Therefore, the finite element model that can truly describe the actual damage of structures is one of the key problems to be solved in the bridge safety assessment. However, the existing research does not take this aspect into account and update the bridge model, so the simulation accuracy is low, which leads to the potential safety hazards of the bridge.

### SUMMARY OF INVENTION

The present invention aims to address the problem that there is no currently refined updating method for a bridge model, which leads to low simulation accuracy.

A bridge model updating method based on modification of vehicle-bridge coupling force, comprising the following steps:

obtaining a dynamic response of a bridge structure under the action of heavy duty vehicle load by sensors arranged on the bridge structure, wherein the measured obtained dynamic response of the bridge structure comprises vertical vibration acceleration and vertical deflection of a bridge;

according to the vertical vibration acceleration aₒ and the vertical deflection yₒ of the bridge at the center of gravity o of the overloaded vehicle and a speed of the heavy duty vehicle U_{vehicle}, reconstructing the response of the table top of the vibration table, and obtaining the interaction force of the vehicle-bridge coupling model;

the nonlinear finite element model of the bridge structure is established, and taking the vehicle-bridge interaction force as external force, and the dynamic response of bridge structure as structural response, and complete the modification of the finite element model of the bridge structure through the nonlinear parameter identification method.

Preferably, the sensor is arranged at a quarter point of a girder of each span of the bridge.

Preferably, the measured obtained dynamic response of the bridge structure comprises the vertical vibration acceleration and vertical deflection of the bridge, during the process of the dynamic response of the bridge, the vertical deflection deformation and vertical vibration acceleration of the bridge at the center of gravity of the heavy duty vehicle in the whole process of crossing the bridge need to be obtained by interpolation method.

Preferably, the process of reconstructing the response of the table top of the vibration table and obtaining the interaction force F of the vehicle-bridge coupling model comprises the following steps:

parking heavy duty vehicles on the vibration table, arranging force plates at the bottom of each wheel, and providing the actually measured dynamic response reconstruction of bridge structure as the response quantity to the vibration table, so that the dynamic response of bridge structure generated by the vibration table is consistent with that corresponding to the center of gravity of heavy duty vehicles during the process of crossing the bridge, and obtaining the interaction force F of the vehicle-bridge coupling model through the force plates;

preferably, through nonlinear parameter identification method, the modification process of finite element model of bridge structure is completed, which is implemented by energy conservation integral method and unscented Kalman filter method, wherein energy conservation integral method is used to solve structural dynamics problems, and unscented Kalman filter method is used to update bridge numerical model;

a specific process of solving the structural dynamics problem by using the energy conservation integral method comprises the following steps:

the time discrete form of equation of motion of bridge nonlinear system is shown in formula (1)

M\ddot{x}ₖ+C\ddot{x}ₖ+Rₖ(x)=Lₖ (1)

wherein, M, C are mass and damping matrices of bridge nonlinear system, x indicates the state variable of state space equation, k is time step, Fₖ is external force of vehicle bridge at k time step, L is load position matrix, \ddot{x}ₖ, \ddot{x}ₖ and xₖ are acceleration, velocity and displacement response of bridge structure at k time step, Rₖ(x) is nonlinear structural restoring force of bridge nonlinear system at k time step;

extending the parameter discrete point amplitude to the state quantity, and obtaining the relationship between speed and acceleration at adjacent time steps by using the constant acceleration Newmark-β method, as shown in formula (3), and completing the parameter identification of bridge finite element model is completed by discrete motion differential equations;

$${\dot{x}}_{k + 1} = \frac{2}{Δ t} ( {x}_{k + 1} - {x}_{n} ) - {\dot{x}}_{k} \\ {\ddot{x}}_{k + 1} = \frac{2}{Δ t} ( {\dot{x}}_{k + 1} - {\dot{x}}_{n} ) - {\ddot{x}}_{k} \qquad ( 3 )$$

wherein Δt is the time step length and k is the time step;

According to formula (1), the expression of system speed \dot{x}ₖ₊₁ with k+1 as time step is obtained:

$${\dot{x}}_{k + 1} = {\dot{x}}_{k} + Δ t {M}^{- 1} [ L {F}_{m} - C {x}_{m} - {R}_{m} ( x ) ] \qquad ( 4 )$$

$${x}_{k + 1} = {x}_{k} + Δ t \frac{{\dot{x}}_{k + 1} + {\dot{x}}_{k}}{2} \qquad ( 5 )$$

wherein xₘ, Fₘ and Rₘ are the average speed, average external force and average restoring force between k and k+1 time step;

the system equation of motion in formula (1) is written as follows

M\ddot{x}_{k,m}+C\dot{x}_{k,m}±R_{k,m}(x)=LF_{k,m} (7)

After right multiplication (xₖ₊₁−xₖ)^{T} of formula (1), a new equation of motion is obtained:

$$\frac{1}{2} {\dot{x}}_{k + 1}^{T} M {\dot{x}}_{k + 1} - \frac{1}{2} {\dot{x}}_{k}^{T} M {\dot{x}}_{k} + {( {x}_{k + 1} - {x}_{k} )}^{T} {C ( \frac{{\dot{x}}_{k + 1} + {\dot{x}}_{k}}{2} )}^{T} + {( {x}_{k + 1} - {x}_{k} )}^{T} {R}_{m} ( x ) = - {( {x}_{k + 1} - {x}_{k} )}^{T} M {\ddot{x}}_{g , m} \qquad ( 8 )$$

equation (8) is regarded as an energy transfer process, and the energy conservation integral method is used to solve structural dynamics problems.

Preferably, the damping matrix of bridge nonlinear system is Rayleigh damping matrix:

C=a₁·M+a₂·K

wherein, a₁ and a₂ are Rayleigh damping coefficients and k is stiffness matrix.

Preferably, the average speed, average external force and average restoring force xₘ, Fₘ and Rₘ between k and k+1 time step are as follows:

$${x}_{m} = \frac{{x}_{k + 1} + {x}_{k}}{2} \\ {F}_{m} = \frac{{F}_{k + 1} + {F}_{k}}{2} \\ {R}_{m} = ( {R}_{k + 1} + {R}_{k} ) / 2$$

a bridge model updating method based on modification of vehicle-bridge coupling force, the system is used for performing the bridge model updating method based on modification of vehicle-bridge coupling force.

A storage medium, wherein, at least one instruction is stored in the storage medium, and the at least one instruction is loaded and executed by a processor to implement the bridge model updating method based on modification of vehicle-bridge coupling force.

A device, the device comprises a processor and a memory, at least one instruction is stored in the storage medium, and the at least one instruction is loaded and executed by a processor to implement the bridge model updating method based on modification of vehicle-bridge coupling force.

Beneficial Effects:

The present invention is based on the real vehicle-vibration table hybrid test, the bridge structure is simulated with multi-degree-of-freedom vibration table to accurately pick up the interaction force between the vehicle and the bridge. On this basis, combining with the measured dynamic response of the bridge, the finite element model of the bridge is accurately modified by means of nonlinear parameter identification. Considering the real situation of the bridge, the numerical model of the bridge is consistent with the real structure situation. The accurate simulation of the numerical model of the bridge provides an analytical basis for the late operation and maintenance of the bridge, especially for the safety assessment of vehicle crossing the bridge. It is of great practical significance to solve the audit problem of bulk-transport.

### BRIEF DESCRIPTION OF THE DRAWINGS

FIG. 1 is a frame diagram of bridge model updating based on modification of vehicle-bridge coupling force according to the present invention;

FIG. 2 is a schematic diagram of bridge field test; wherein j is the j^{th} span of bridge, i is the number of bridge units, i=1 . . . 4, Aji is the measured dynamic response of the ith unit of the jth span of bridge, Lj is the length of the j^{th} span of bridge;

FIG. 3 is an acquisition process of dynamic response of bridge structure at the center of gravity o of heavy-duty vehicle; and

FIG. 4 is a schematic diagram of vehicle-vibration table test;

wherein, 1 is the heavy-duty vehicle, 2 is the measured dynamic response of the bridge, 3 is the pressure and shear force measuring version, and 4 is the vibration table.

### DESCRIPTION OF THE ILLUSTRATED EMBODIMENTS

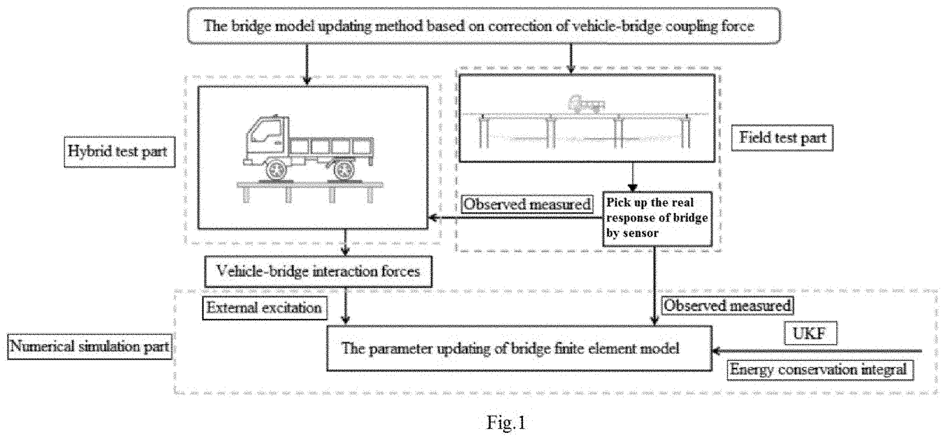

EMBODIMENTS ONE: This implementation will be explained with reference to FIG. 1.

This implementation is a bridge model updating method based on modification of vehicle-bridge coupling force, comprising the following steps:

obtaining a dynamic response of a bridge structure under the action of heavy duty vehicle load by sensors have arranged on the bridge structure, wherein the measured obtained dynamic response of the bridge structure comprises vertical vibration acceleration and vertical deflection of a bridge; the sensor is arranged at a quarter point of a girder of each span of the bridge.

Referring to the Definition Method of Heavy Load and Heavy Load Traffic on Cement Concrete Pavement for heavy load in heavy load vehicles, as shown in table 1:

TABLE 1
heavy load Limit

| | High-speed | Second | Third |
|---|---|---|---|
| Highway classification | first class | class | class |
| single-axle-double-wheel | 140 | 120 | 100 |
| set/KN | | | |
| double-axle-double-wheel | 330 | 280 | 230 |
| set/KN | | | |

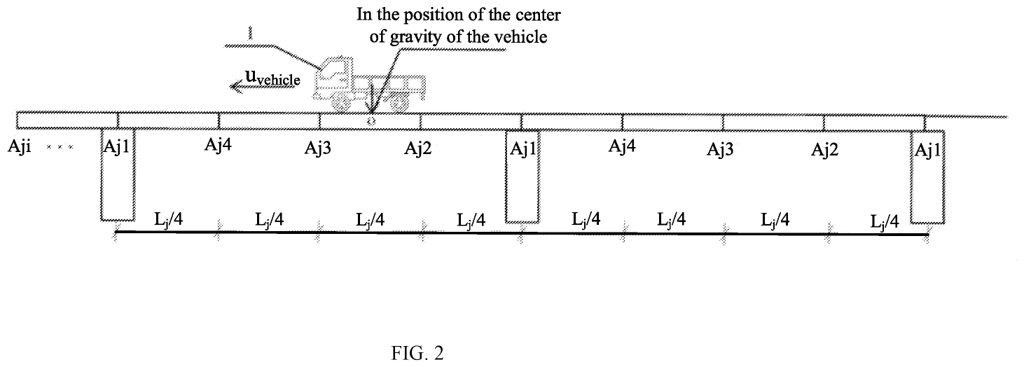

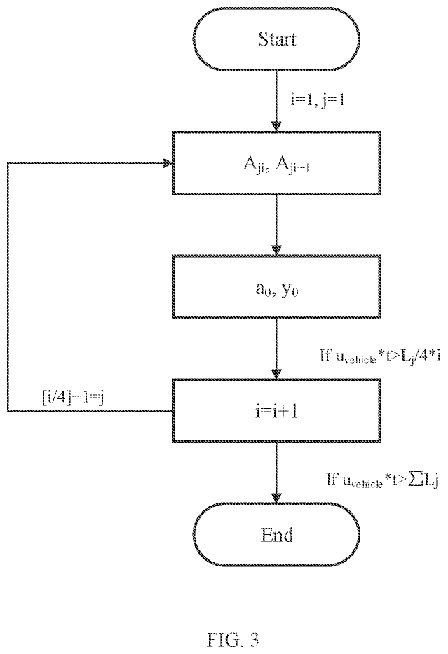

FIG. 2 shows the schematic diagram of bridge field test. When the heavy-duty vehicle 1 travels at a constant speed along the length of the bridge at a speed U_{vehicle}, the vertical vibration acceleration aₒ and vertical deflection yₒ of the bridge corresponding to the center of gravity o of the heavy-duty vehicle are obtained by difference processing according to the data of adjacent sensors. FIG. 3 shows the acquisition process of the dynamic response of bridge structure at the center o of heavy-duty vehicle. The actual span number of bridge is j, and each span bridge is divided into four equal-length units according to the sensor position. According to the actual running position of heavy-duty vehicle, the i^{th} unit of the j^{th} span of bridge where heavy-duty vehicle is located is judged, and then the dynamic response of bridge structure at the center o of heavy-duty vehicle is obtained by linear interpolation using the measured data at both ends Aⱼᵢ and Aⱼᵢ₊₁ of the i^{th} unit. That is to say, the vertical deflection deformation and vertical vibration acceleration of the bridge at the center of gravity of the heavy-duty vehicle are obtained by interpolation method during the whole process of crossing the bridge.

According to the obtained bridge vertical vibration acceleration aₒ and vertical deflection yₒ at the center of gravity o of heavy-duty vehicles, as well as the heavy-duty horizontal running speed U_{vehicle}, reconstructing the response of the table top of the vibration table through hybrid experiments, so that the vertical displacement and table top vertical acceleration after the reconstruction of the table top are consistent with yₒ and aₒ, and the horizontal movement speed of table top is U_{vehicle}, and its movement direction is opposite to that of heavy-duty vehicles. The heavy-duty vehicles are simulated by vehicle-bridge relative movement. At this time, the vertical data and horizontal data of the measured forces are used to obtain the vertical and horizontal vehicle-bridge interaction forces F of the vehicle-vibration table.

The reconstruction is implemented by a hybrid experiment method, wherein the experimental substructure is a full-scale heavy-duty vehicle and the numerical substructure is a finite element model of the bridge structure.

During the implementation of hybrid experiment simulation, the bridge is divided into numerical substructures, and finite element simulation is carried out. Prototype, full-scale heavy-duty vehicle is selected as the test substructure, and the loading is simulated by vibration table array.

\textcircled{1} Determining the system initial value at the time when the initial time step t=0; \textcircled{2} calculating the movement amount of the bridge model at the initial time; \textcircled{3} consider that smoothness of the road surface, transmitting the movement amount of the couple interface to the loading control system of the vibration table array, loading the selected heavy-duty vehicle model, and obtaining the acting force of the heavy-duty vehicle on the interface in real time through a force measuring apparatus; \textcircled{4} restoring the state quantity of the heavy-duty vehicle to the initial state; \textcircled{5} Considering the vehicle speed, according to the vehicle acting force in the computer, the bridge response in step t+Δt is calculated by numerical integration method, and the motion state of the vehicle-bridge coupling section in this step and all previous restoring forces form a vector F, which is transmitted to the vibration table array loading system; \textcircled{6} The vibration table array loading system loads the heavy-duty vehicle from the initial time to the next time step, and transmits the force of the heavy-duty vehicle on the interface to the computer's multi-scale model to calculate the structural response, repeating \textcircled{4}-\textcircled{6} until the calculation is completed.

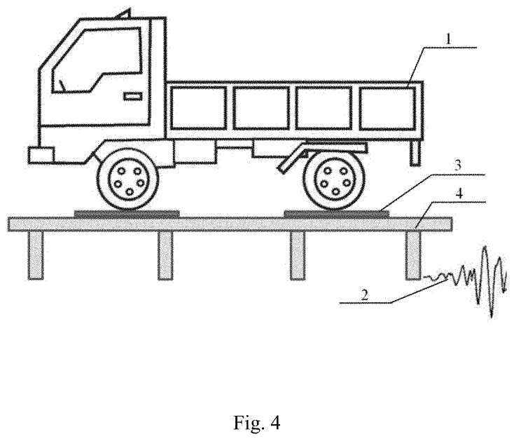

As shown in FIG. 4, in the reconstruction process, the center of gravity of the vehicle is determined according to the type and counterweight of the heavy-duty vehicle, the heavy-duty vehicle is parked on the vibration table array, the force measuring plate is arranged at the bottom of the wheel, and the actually measured dynamic response reconstruction of the bridge structure is provided to the vibration table as the response quantity, so that the dynamic response of the bridge structure generated by the vibration table is consistent with the dynamic response of the bridge structure when the vehicle crosses the bridge. At this time, the interaction force of the vehicle-bridge coupling model can be obtained through the force measuring plate; the process of obtaining the interaction force of the vehicle-bridge coupling model through the force measuring plate comprises the following steps:

The table top of the vibration table is controlled so that the vertical displacement and vertical acceleration of the table top after reconstruction are consistent with the vertical displacement and vertical acceleration of the bridge at the position corresponding to the center of gravity of the vehicle. At this time, the vertical force and horizontal shear force at the contact point between the vehicle and the vibration table are measured by the force measuring plate, thus obtaining the vehicle-vibration table interaction force F.

The nonlinear finite element model of the bridge structure is established, and taking the vehicle-bridge interaction force as external force, and the measured obtained dynamic response of bridge structure as structural response, and complete the modification of the finite element model of the bridge structure through the nonlinear parameter identification method, the bridge numerical model can truly reflect the actual damage of the bridge and reduce the model error.

In the specific process of modification the finite element model of bridge structure, taking the vehicle-bridge interaction force F as the external excitation of the nonlinear finite element model of bridge, and the inversion of bridge parameters in the bridge numerical model is completed by the joint application of energy conservation integral method and unscented Kalman filter method. The specific model updating process is as follows:

the time discrete form of equation of motion of bridge nonlinear system is shown in formula (1)

M\ddot{x}ₖ+C\dot{x}ₖ+Rₖ(x)=LFₖ (1)

wherein, M, C are mass and damping matrices of bridge nonlinear system, x indicates the state variable of state space equation, k is time step, Fₖ is external force of vehicle bridge at k time step, L is load position matrix, \ddot{x}ₖ, \dot{x}ₖ and xₖ are acceleration, velocity and displacement response of bridge structure at k time step, Rₖ(x) is nonlinear structural restoring force of bridge nonlinear system at k time step; the damping of bridge nonlinear system is Rayleigh damping:

C=a₁·M+a₂·K (2)

wherein, a₁ and a₂ are Rayleigh damping coefficients and k is stiffness matrix;

extending the parameter discrete point amplitude to the state quantity, and the constant acceleration Newmark-β method is used that can obtain the relationship between the speed and acceleration at adjacent time steps. as shown in formula (3), and completing the parameter identification of bridge finite element model by discrete differential equations of motion, the parameters mainly comprise the physical parameters of important materials of bridges, especially the constitutive parameters of concrete and steel structures.

$${\dot{x}}_{k + 1} = \frac{2}{Δ t} ( {x}_{k + 1} - {x}_{n} ) - {\dot{x}}_{k} {\ddot{x}}_{k + 1} = \frac{2}{Δ t} ( {\dot{x}}_{k + 1} - {\dot{x}}_{n} ) - {\ddot{x}}_{k} \qquad ( 3 )$$

wherein Δt is the time step length and k is the time step.

According to formula (1), the expression of speed \dot{x}ₖ₊₁ with k+1 as time step can be obtained:

$${\dot{x}}_{k + 1} = {\dot{x}}_{k} + Δ t {M}^{- 1} [ {LF}_{m} - C {x}_{m} - {R}_{m} ( x ) ] \qquad ( 4 )$$

$${x}_{k + 1} = {x}_{k} + Δ t \frac{{\dot{x}}_{k + 1} + {\dot{x}}_{k}}{2} \qquad ( 5 )$$

wherein Xₘ, Fₘ and Rₘ are the average speed, average external force and average restoring force between k and k+1 time step; wherein

$${\dot{x}}_{m} = \frac{{\dot{x}}_{k + 1} + {\dot{x}}_{k}}{2} {x}_{m} = \frac{{x}_{k + 1} + {x}_{k}}{2} {F}_{m} = \frac{{F}_{k + 1} + {F}_{k}}{2} {R}_{m} = ( {R}_{k + 1} + {R}_{k} ) / 2 \qquad ( 6 )$$

at this time, the equation of motion in formula (1) of the bridge nonlinear system can be written as follows

M\ddot{x}_{k,m}+C\dot{x}_{k,m}+R_{k,m}(x)=LF_{k,m} (7)

\ddot{x}_{k,m}, \dot{x}_{k,m} and x_{k,m} are the average acceleration, average velocity and average displacement response of the bridge structure at k time, R_{k,m}(x) are the average restoring force of the nonlinear structure of the bridge nonlinear system at k time, and F_{k,m} is the average external force of the vehicle bridge at k time;

After right multiplication (xₖ₊₁−xₖ)^{T} of formula (1), a new equation of motion can be obtained:

$$\frac{1}{2} {\dot{x}}_{k + 1}^{T} M {\dot{x}}_{k + 1} - \frac{1}{2} {\dot{x}}_{k}^{T} M {\dot{x}}_{k} + {( {x}_{k + 1} - {x}_{k} )}^{T} {C ( \frac{{\dot{x}}_{k + 1} + {\dot{x}}_{k}}{2} )}^{T} + {( {x}_{k + 1} - {x}_{k} )}^{T} {R}_{m} ( x ) = - {( {x}_{k + 1} - {x}_{k} )}^{T} M {\ddot{x}}_{g , m} \qquad ( 8 )$$

equation (8) reflects the energy transfer process in the bridge nonlinear system. Considering the external input of the system, the system equation of motion always satisfies the principle of energy conservation. Therefore, the energy conservation integration method can be applied to solve structural dynamics problems. Combining the energy conservation integration method with unscented Kalman filter method, the fine identification of parameters in bridge nonlinear finite element model can be implemented, and then the updating process of bridge finite element model can be completed.

The updating process of the bridge numerical model of the unscented Kalman filter method is as follows:

discrete state space equation of bridge nonlinear system can be written as:

Xₖ=F(Xₖ₋₁, uₖ₋₁, wₖ₋₁) (9)

Xₖ is the state vector of bridge nonlinear system at time k, Xₖ=[xₖ \dot{x}ₖ], uₖ₋₁ are the input of bridge nonlinear system at time k−1, wₖ₋₁ is the noise vector of system process at time k−1, and F is the nonlinear function of state vector X. Equation (9) can also be expressed as equation (13) in the state space.

Discrete observation function can be written as

yₖ=h(Xₖ,uₖ,vₖ) (10)

wherein, V is the observation noise, and the initial value is defined as X₀=E[X], P₀=E[(X₀−\hat{X}₀)(X₀−\hat{X}₀)^{T}], wherein \hat{X}₀ represents the estimate of X₀ and E[X], is the expectation; for the k−1th time step, 2n+1 sampling points can construct the estimated value of the system state vector at k−1 time step by the following formula:

\hat{⋅}ₖ₋₁=[\hat{x}ₖ₋₁,\hat{x}ₖ₋₁+\sqrt{(i+λ)Pₖ₋₁},\hat{x}ₖ₋₁−\sqrt{(i+λ)Pₖ₋₁}] (11)

wherein, i is the parameter in unscented Kalman filter algorithm, wherein λ is a parameter controlling the distance from each sigma point to the mean value.

The mean \hat{x}ₖ⁻ and covariance Pₖ⁻ of the prior estimation of 2n+1 sampling points can be obtained by the weight matrix of each point:

$$\begin{matrix}{\hat{x}}_{k}^{-} = {\hat{χ}}_{k}^{-} {W}_{m} & ( 12 )\end{matrix}$$

$$\begin{matrix}{P}_{k}^{-} = {\hat{x}}_{k}^{-} {W [ {\hat{x}}_{k}^{-} ]}^{T} + {Q}_{k - 1} & ( 13 )\end{matrix}$$

$${W}_{m} = ( I - [ {W}_{m}^{0} , … , {W}_{m}^{2 n} ] ) ⨯ diag ( {W}_{c}^{0} … {W}_{c}^{2 n} ) ⨯ {( I - [ {W}_{m}^{0} , … , {W}_{m}^{2 n} ] )}^{T} \qquad ( 14 )$$

$$\begin{matrix}{W}_{m}^{i} = {W}_{c}^{i} = \{ \begin{matrix}λ / ( n + λ ) , i = 0 \\ λ / 2 ( n + λ ) , i = 1 , … , 2 n\end{matrix} & ( 15 )\end{matrix}$$

wherein, Wₘ is the weight matrix with 2n weight coefficients, and n is the number of elements in the state vector; I is an identity matrix with a dimension of 2n×2n; Qₖ₋₁ is the covariance matrix of process noise in step k−1 of the state equation.

The unscented Kalman filter filtering algorithm is used to recursively update the observed predicted values ŷₖ⁻, weighted average values of observed predicted values μₖ and process parameters Sₖ and Cₖ after UT transformation as follows:

y̅ₖ⁻=h(χ̅ₖ₋₁⁻, uₖ,k) (16)

μₖ=ŷₖ⁻Wₘ (17)

Sₖ=ŷₖ⁻W[ŷₖ⁻]^{T}+Rₖ (18)

Cₖ=\hat{x}ₖ⁻W[ŷₖ⁻]^{T} (19)

Further, the filter gain K is calculated, and the estimated value \hat{x}ₖ of the mean value of the state quantity and the covariance matrix P are updated.

Kₖ=CₖSₖ⁻¹ (20)

\hat{x}ₖ=\hat{x}ₖ⁻+Kₖ[yₖ−μₖ] (21)

Pₖ=Pₖ⁻−KₖSₖKₖ^{T} (22)

wherein, yₖ—the observation of the k step. Through the above steps, the cyclic recursive operation is carried out to complete the estimation of the state quantity, and the bridge structural parameters are placed in the state quantity, the nonlinear parameters of the bridge can be identified by the above process, the parameters comprise the physical parameters of the important materials of the bridge, especially the constitutive parameters of concrete and steel structures, such as modulus, Poisson's ratio and other nonlinear constitutive model parameters. Specifically, the main parameters can be determined by sensitivity analysis of the structural response to the model parameters.

### Embodiments Two

This implementation is a bridge model updating method based on modification of vehicle-bridge coupling force, the system is used for performing the bridge model updating method based on modification of vehicle-bridge coupling force.

### Embodiments Three

This implementation is a storage medium, wherein, at least one instruction is stored in the storage medium, and the at least one instruction is loaded and executed by a processor to implement the bridge model updating method based on modification of vehicle-bridge coupling force.

### Embodiments Four

This implementation is a device, the device comprises a processor and a memory, at least one instruction is stored in the storage medium, and the at least one instruction is loaded and executed by a processor to implement the bridge model updating method based on modification of vehicle-bridge coupling force.

There are many other embodiments of the invention. Without departing from the spirit and essence of the invention, those skilled in the art can make various corresponding changes and modifications according to the invention, but these corresponding changes and modifications should belong to the protection scope of the appended claims of the invention.

What is claimed is:

1. A bridge model updating method based on modification of vehicle-bridge coupling force, comprising the following steps:
obtaining a dynamic response of a bridge structure under the action of heavy duty vehicle load by sensors arranged on the bridge structure, wherein the measured obtained dynamic response of the bridge structure comprises vertical vibration acceleration and vertical deflection of a bridge;
according to the vertical vibration acceleration aₒ and the vertical deflection yₒ of the bridge at a center of gravity o of the overloaded vehicle and a speed of the heavy duty vehicle U_{vehicle}, reconstructing a response of a table top of a vibration table, and obtaining interaction force of a vehicle-bridge coupling model;
establishing a nonlinear finite element model of the bridge structure, and taking the vehicle-bridge interaction force as external force and the dynamic response of bridge structure as a structural response, and completing modification of the finite element model of the bridge structure through a nonlinear parameter identification method.

2. The bridge model updating method according to claim 1, wherein the sensors are arranged at quarter points of a girder of each span of the bridge.

3. The bridge model updating method according to claim 2, wherein the measured obtained dynamic response of the bridge structure comprises the vertical vibration acceleration and vertical deflection of the bridge, during the process of the dynamic response of the bridge, the vertical deflection deformation and vertical vibration acceleration of the bridge at the center of gravity of the heavy duty vehicle in the whole process of crossing the bridge need to be obtained by interpolation method.

4. The bridge model updating method according to claim 1, wherein, the process of reconstructing the response of the table top of the vibration table and obtaining the interaction force F of the vehicle-bridge coupling model comprises the following steps:
parking the heavy duty vehicle on the vibration table, arranging a force plate at the bottom of each wheel, and providing an actually measured dynamic response reconstruction of the bridge structure as response quantity to the vibration table, so that the dynamic response of the bridge structure generated by the vibration table is consistent with that corresponding to the center of gravity of the heavy duty vehicle during the process of crossing the bridge, and obtaining the interaction force F of the vehicle-bridge coupling model through the force plates.

5. The bridge model updating method according to claim 4, wherein through nonlinear parameter identification method, the modification process of the finite element model of the bridge structure is completed, which is implemented by an energy conservation integral method and a unscented Kalman filter method, wherein the energy conservation integral method is used to solve structural dynamics problems, and the unscented Kalman filter method is used to update a bridge numerical model;
a specific process of solving the structural dynamics problems by using the energy conservation integral method comprises the following steps:
a time discrete form of equation of motion of a bridge nonlinear system is shown in formula (1)
M\ddot{x}ₖ+C\dot{x}ₖ+Rₖ(x)=LFₖ (1)
wherein, M, C are mass and damping matric of the bridge nonlinear system, x indicates a state variable of state space equation, k is a time step, Fₖ is external force of vehicle bridge at k time step, L is load position matrix, \hat{x}ₖ, \dot{x}ₖ and xₖ are acceleration, velocity and displacement response of the bridge structure at k time step, Rₖ(x) is nonlinear structural restoring force of the bridge nonlinear system at k time step;
extending parameter discrete point amplitude to the state quantity, and obtaining the relationship between speed and acceleration at adjacent time steps by using the constant acceleration Newmark-β method, as shown in formula (3), and completing parameter identification of the bridge finite element model by discrete motion differential equations;
$${\dot{x}}_{k + 1} = \frac{2}{Δ t} ( {x}_{k + 1} - {x}_{n} ) - {\dot{x}}_{k} \\ {\ddot{x}}_{k + 1} = \frac{2}{Δ t} ( {\dot{x}}_{k + 1} - {\dot{x}}_{n} ) - {\ddot{x}}_{k} \qquad ( 3 )$$
wherein Δt is a time step length and k is a time step;
according to formula (1), obtaining an expression of system speed \dot{x}ₖ₊₁ with k+1 as a time step:
$${\dot{x}}_{k + 1} = {\dot{x}}_{k} + Δ t {M}^{- 1} [ {LF}_{m} - C {x}_{m} - {R}_{m} ( x ) ] \qquad ( 4 )$$
$${x}_{k + 1} = {x}_{k} + Δ t \frac{{\dot{x}}_{k + 1} + {\dot{x}}_{k}}{2} \qquad ( 5 )$$
wherein Xₘ, Fₘ and Rₘ are average speed, average external force and average restoring force between k and k+1 time step;
the system equation of motion in formula (1) is written as follows:
M\ddot{x}_{k,m}+C\dot{x}_{k,m}+R_{k,m}(x)=LF_{k,m} (7)
after right multiplication (xₖ₊₁−xₖ)^{T} of formula (1), obtaining a new equation of motion:
$$\frac{1}{2} {\dot{x}}_{k + 1}^{T} M {\dot{x}}_{k + 1} - \frac{1}{2} {\dot{x}}_{k}^{T} M {\dot{x}}_{k} + {( {x}_{k + 1} - {x}_{k} )}^{T} {C ( \frac{{\dot{x}}_{k + 1} + {\dot{x}}_{k}}{2} )}^{T} + {( {x}_{k + 1} - {x}_{k} )}^{T} {R}_{m} ( x ) = - {( {x}_{k + 1} - {x}_{k} )}^{T} M {\ddot{x}}_{g , m} \qquad ( 8 )$$
regarding equation (8) as an energy transfer process, and using the energy conservation integral method to solve structural dynamics problems.

6. The bridge model updating method according to claim 5, wherein the damping matrix of the bridge nonlinear system is Rayleigh damping matrix:
C=a₁·M+a₂·K
wherein a₁ and a₂ are Rayleigh damping coefficients and k is stiffness matrix.

7. The bridge model updating method according to claim 5, wherein the average speed, average external force and average restoring force xₘ, Fₘ and Rₘ between k and k+1 time step are as follows:
$${x}_{m} = \frac{{x}_{k + 1} + {x}_{k}}{2} {F}_{m} = \frac{{F}_{k + 1} + {F}_{k}}{2} {R}_{m} = ( {R}_{k + 1} + {R}_{k} ) / 2.$$
